(19) United States
(12) Patent Application Publication
(10) Pub. No.: US 2022/0245960 A1
(43) Pub. Date: Aug. 4, 2022

(54) ELECTRONIC DEVICE

(71) Applicant: Egis Technology Inc., Hsinchu City (TW)

(72) Inventors: Kuan-Yi Lin, Hsinchu City (TW); Tong-Long Fu, Hsinchu City (TW); Chun-Ching Tseng, Hsinchu City (TW)

(73) Assignee: Egis Technology Inc., Hsinchu City (TW)

(21) Appl. No.: 17/609,791

(22) PCT Filed: Feb. 18, 2020
(86) PCT No.: PCT/CN2020/075660

§ 371 Date: Nov. 9, 2021

Related U.S. Application Data
(60) Provisional application No. 62/863,270, filed on Jun. 19, 2019.
(60) Provisional application No. 62/864,586, filed on Jun. 21, 2019.

(51) Int. Cl. G06V 40/13; G09G 3/3208

(52) U.S. Cl. CPC G06V 40/1318; G09G 2320/0626; G09G 2360/16; G09G 3/3208

(57) ABSTRACT

The present invention provides an electronic device, used for sensing a fingerprint image of a finger and comprising a display module, a sensing module, and a controller. The display module comprises a plurality of light emitting pixels arranged in an array, has a fingerprint sensing region, and is configured to provide an irradiation beam to the finger. The sensing module is disposed below the fingerprint sensing region and is configured to receive the irradiation beam reaching the sensing module after being reflected by the finger, so as to generate the fingerprint image. The controller is electrically connected to the display module to control light emission of the display module, wherein the controller calculates a distribution curve of light intensity with respect to position of a plurality of different colored lights at a specific time to control light emission of each light emitting pixel of the display module.

### TECHNICAL FIELD

This disclosure relates to an electronic device, and in particular to an electronic device capable of sensing a fingerprint.

### DESCRIPTION OF RELATED ART

With continuous evolution and improvement of electronic technologies and manufacturing technologies, informative electronic products are also constantly innovated. Computers, mobile phones, cameras and other electronic products have become essential tools for people in the modern day. In addition, fingerprint sensing devices also have to be integrated into current smart mobile devices, so as to enhance security of the smart mobile devices and to support more smart functions.

Currently, a user may press a finger on a display of a mobile phone to perform fingerprint sensing. In order to improve a signal-to-noise ratio of a fingerprint image sensed by a fingerprint sensing device, an exposure time for sensing the fingerprint is usually increased. For under-screen fingerprint sensing, the fingerprint image passes through a display panel before being received by a sensing module below the display panel. However, light passing through a circuit layer in the display panel is often accompanied by generation of moiré effect, and causes the fingerprint image to have the phenomenon of interlacing bright and dark spots. However, increasing the exposure time when sensing the fingerprint has a risk of overexposing the bright spots in the fingerprint image. Once the fingerprint image is overexposed, even a back-end software would be unable to correct it, which reduces credibility of the fingerprint image obtained by the fingerprint sensing device. Therefore, how to reduce risk of over-exposure of a sensing signal remains a challenge for those skilled in the art.

### SUMMARY

This disclosure provides an electronic device, which has a good fingerprint sensing function.

An embodiment of the disclosure provides an electronic device that is configured to sense a fingerprint image of a finger, and includes a display module, a sensing module, and a controller. The display module includes multiple light emitting pixels arranged in an array, has a fingerprint sensing region, and is configured to provide an irradiation beam to the finger. The sensing module is disposed below the fingerprint sensing region to receive the irradiation beam that reaches the sensing module after being reflected by the finger, so as to generate the fingerprint image. The controller is electrically connected to the display module, so as to control light emission of the display module. The controller calculates multiple distribution curves of light intensity with respect to position of different colored lights at a specific time, so as to control light emission of each of the light emitting pixels of the display module.

In the electronic device according to the embodiment of the disclosure, in the electronic device according to the embodiment of the disclosure, since the controller may calculate the multiple distribution curves of the light intensity with respect to the position of the different colored lights at a specific time, so as to control the light emission of each of the light emitting pixels of the display module, the electronic device according to the embodiment of the disclosure can have a good sensing function.

### BRIEF DESCRIPTION OF THE DRAWINGS

The accompanying drawings are included for further understanding of the disclosure, and the drawings are incorporated into this specification and constitute a part of this specification. The drawings illustrate the embodiments of the disclosure, and together with the descriptions serve to explain the principles of the disclosure.

FIG. 1 is a schematic cross-sectional view of an electronic device according to an embodiment of the disclosure.

FIG. 2 is a schematic view of an energy velocity curve according to an embodiment of the disclosure.

FIG. 3 is a schematic view of a distribution curve and an average curve according to an embodiment of the disclosure.

FIG. 4 is a schematic top view of the fingerprint sensing region of the display module in FIG. 1.

### DESCRIPTION OF REFERENCE SIGNS OF THE ACCOMPANYING DRAWINGS

10: finger
20: display module
22: fingerprint sensing region
40: optical module
60: sensing module
80: controller
100: electronic device
222: first region
224: second region
C1, C2, D1, D2: curve
E: average curve
L: compensation line

### DESCRIPTION OF THE EMBODIMENTS

Reference will now be made in detail to exemplary embodiments of the disclosure, and examples of the exemplary embodiments are illustrated in the accompanying drawings. Whenever possible, the same reference numerals are used in the drawings and descriptions to indicate the same or similar parts.

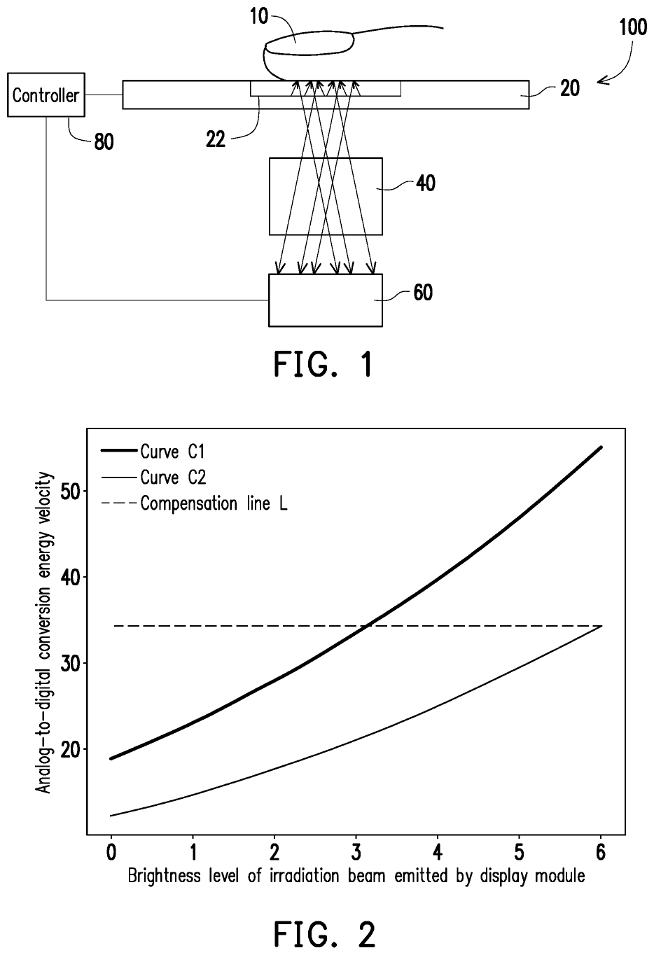

FIG. 1A is a schematic cross-sectional view of an electronic device according to an embodiment of the disclosure. With reference to FIG. 1A, an electronic device 100 of the embodiment is configured to sense a fingerprint image of a finger 10 of a user, and the electronic device 100 includes a display module 20 and a sensing module 60. The display module 20 has a fingerprint sensing region 22, and the display module 20 includes a light emitting element, for example, multiple light emitting pixels arranged in an array, which is configured to provide an irradiation beam to the finger 10 of the user, and the user may place the finger 10 on the fingerprint sensing region 22 to perform fingerprint sensing.

In the embodiment, the display module 20 is, for example, a display panel (such as a transparent display panel), a touch display panel (such as a transparent touch display panel), or a combination of the above and a finger pressure plate. For example, the display module 20 is, for example, an organic light emitting diode display panel (OLED display panel), but the disclosure is not limited thereto. Alternatively, the display module 20 may be a touch display panel, such as an OLED display panel having multiple touch electrodes. The multiple touch electrodes may be formed on an outer surface of the OLED display panel or be embedded in the OLED display panel, and the multiple touch electrodes may perform touch detection by self-capacitance or mutual capacitance. Alternatively, the display module 20 may be a combination of a finger pressure plate and a display panel or a combination of a finger pressure plate and a touch display panel.

In the embodiment, the electronic device 100 may further include an optical module 40, which is disposed between the fingerprint sensing region 22 and the sensing module 60, so as to guide an irradiation beam reflected by the finger 10 to the sensing module 60 to form the fingerprint image. The optical module 40 is, for example, a lens assembly that has a collimator structure, and/or includes a micro-lens layer and/or a pin-holes layer. In the embodiment, the optical module 40 is, for example, a lens assembly, including a combination of one or more optical lenses with refractive power. For example, various combinations of non-planar lenses such as a biconcave lens, a biconvex lens, a meniscus lens, a convex-concave lens, a plano-convex lens, and a plano-concave lens. However, the disclosure does not limit the form and the type of the optical module 40. For example, the optical module 40 is composed of two lenses, but in other embodiments, it may be composed of three lenses or four lenses, and the disclosure is not limited thereto.

In the embodiment, the sensing module 60 is disposed below the fingerprint sensing region 22, and is configured to receive the irradiation beam that reaches the sensing module after being reflected by the finger 10, so as to generate a fingerprint image. The sensing module 60 includes an image sensor. The image sensor includes multiple sensing pixels arranged in a sensing array. Each of the sensing pixels may include at least one photodiode, but the disclosure is not limited thereto. When fingerprint sensing is being performed, the user places the finger 10 close to or on the fingerprint sensing region 22 of the display module 20, and the display module 20 emits the irradiation beam to irradiate the finger 10, which is sequentially transmitted through the display module 20 and the optical module 40 to be transmitted to the sensing module 60 to perform fingerprint sensing after being reflected by the finger.

In addition, the electronic device 100 also includes a controller 80, which is electrically connected to the display module 20, so as to control light emission of the display module 20. In the embodiment, the electronic device 100 may be a handheld electronic device, such as a smart phone, a tablet computer, and other handheld electronic devices, and the display module 20 may serve as a display to show a frame to be viewed by the user when fingerprint recognition is not performed. During the fingerprint recognition, the display module 20 may emit light from the entire surface or only in the fingerprint sensing region 22, so as to generate the irradiation beam to illuminate the finger 10.

In addition, in the embodiment, the controller 80 may also be electrically connected to the sensing module 60, so as to synchronize a light emission time of the display module 20 with a sensing time of the sensing module 60.

Furthermore, in the embodiment, the display module 20 may have a circuit layer. When the irradiation beam passes through the display module 20, the irradiation beam also passes through the circuit layer. Therefore, the fingerprint image obtained by the sensing module 60 is affected by the moiré effect and has a phenomenon of interlacing bright and dark spots. In order to reduce impact of the moiré effect and increase an exposure time of fingerprint sensing, so as to increase a signal-to-noise ratio of the fingerprint image, the electronic device 100 according to the embodiment of the disclosure controls an intensity ratio between lights of different colors emitted by each of the light emitting pixels.

Specifically, before the electronic device 100 of the embodiment is shipped from the factory, an inspector may use the display module 20 to emit a detection beam, and use a calibration equipment (such as a white box or a mirror) to reflect the detection beam to the sensing module 60. The detection beam is, for example, one of a red light, a green light, and a blue light, and has a maximum intensity. In general, the sensing module 60 has a highest quantum efficiency when receiving the green light, therefore the detection beam is preferably the green light.

In the embodiment, the sensing module 60 continuously receives the detection beam from the fingerprint sensing region 22 and obtains an accumulated total energy within a specific time. Then, the controller 80 calculates a moiré response of a colored light of the detection beam according to the obtained accumulated total energy of the detection beam at the fingerprint sensing region 22 within the specific time. For example, the specific time is 10 milliseconds, for example. The inspector may analyze top 10% of images of the above-mentioned accumulated total energy, so as to analyze an impact of a peak in the images of the accumulated total energy, such as a position, a value, a growth rate, etc. of the peak.

Furthermore, the controller 80 of the embodiment correspondingly calculates an accumulated total energy of other colored lights at the fingerprint sensing region 22 within a specific time according to the above-mentioned moiré response of the colored light of the detection beam, so as to calculate a growth rate ratio (hereinafter referred to as energy velocity) of the accumulated total energy per unit time with respect to the moiré response of the red light, the green light, and the blue light. A calculation method of the aforementioned accumulated total energy of the other colored lights within a specific time is, for example, through a look-up table. The unit time is, for example, 1 millisecond.

FIG. 2 is a schematic view of an energy velocity curve according to an embodiment of the disclosure. In FIG. 2, the vertical axis represents analog-to-digital conversion energy velocities, and the horizontal axis represents brightness levels of the irradiation beam emitted by the display module. For convenience of description, 6 on the horizontal axis represent a maximum brightness, and 0 on the horizontal axis represents a brightness that is 6 interval units away from the maximum brightness. Taking a 2⁸-bit digital signal as an example, the maximum brightness is 255 and a minimum brightness is 0. The interval unit is, for example, 10, therefore 0 on the horizontal axis in FIG. 2 may represent a digital brightness of 195. However, the disclosure is not limited thereto, and value of the interval unit should be determined according to an actual design.

With reference to FIG. 2, in the embodiment, the controller 80 calculates an energy velocity curve of an analog-to-digital conversion energy velocity with respect to in-between the brightness levels of the red light, the green light, and the blue light emitted by each of the light emitting pixels according to the growth rate ratio of the accumulated total energy per unit time with respect to the moiré response of the red light, the green light, and the blue light. FIG. 2 simply illustrates an energy velocity curve C1 of the green light and an energy velocity curve C2 of the blue light of one of the pixels at the fingerprint sensing region 22. Since the sensing module 60 has the highest quantum efficiency when receiving the green light, the energy velocity of the curve C1 in FIG. 2 corresponding to each of the brightness levels is greater than the energy velocity of the curve C2.

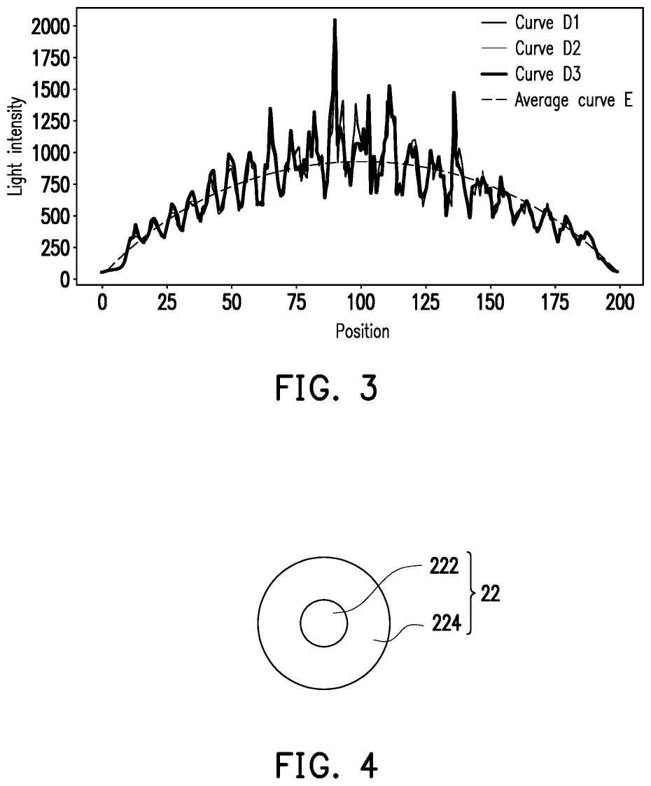

FIG. 3 is a schematic view of a distribution curve and an average curve according to an embodiment of the disclosure. In FIG. 3, the vertical axis represents light intensities, and the horizontal axis represents positions. For ease of illustration, FIG. 3 simply illustrates a curve diagram of light intensity of a row of the light emitting pixel array with respect to position. With reference to FIGS. 2 and 3 concurrently, in the embodiment, the controller 80 calculates multiple distribution curves of the light intensity with respect to the position of the different colored lights at a specific time corresponding to a fitting model according to the above-mentioned energy velocity curve of the analog-to-digital conversion energy velocities with respect to in-between the brightness levels of the green light and the blue light (or also including the red light) emitted by each of the light emitting pixels in conjunction with the fitting model, so as to control light emission of each of the light emitting pixels of the display module 20. The fitting model selects a reference analog-to-digital conversion energy velocity for the controller 80, obtains intersection points of a straight line formed by the reference analog-to-digital conversion energy velocity at the multiple different brightness levels and the multiple energy velocity curves of the analog-to-digital conversion energy velocity with respect to in-between the brightness levels of the green light and the blue light (or also including the red light), and uses brightness levels corresponding to the interception points to respectively serve as a light intensity of the green light and the blue light (or also including the red light) of each of the light emitting pixels corresponding to the intersection points.

For example, the fitting model is, for example, a compensation line L in FIG. 2. At a corresponding pixel position in FIG. 2, the controller 80 takes the analog-to-digital conversion energy velocity corresponding to the brightness level of the energy velocity curve (that is, curve C2) of the analog-to-digital conversion energy velocity with respect to the brightness levels of the blue light as the reference analog-to-digital conversion energy velocity, and the compensation line L as a straight line formed by the reference analog-to-digital conversion energy velocity at the multiple different brightness levels. That is, the controller 80 uses an analog-to-digital conversion energy velocity 35 corresponding to the curve C2 at a brightness level 6 as the reference analog-to-digital conversion energy velocity, and the compensation line L is a straight line formed by the analog-to-digital conversion energy velocity 35 at the different brightness levels. A brightness level corresponding to an intersection point of the compensation line L and the curve C1 (that is, green light) is, for example, 3, and a brightness level corresponding to an intersection point of the compensation line L and the curve C2 (that is, blue light) is, for example, 6. In the embodiment, the controller 80 then uses the green light brightness level 3 and the blue light brightness level 6 to serve as outputs of the light intensity of the pixel position. Deducing by analogy, the controller 80 may calculate the light intensity each of the colored lights should output at each of the light emitting pixels, which is also the distribution curve in FIG. 3.

According to the fitting model of the compensation line L in FIG. 2, for example, a distribution curve D1 in FIG. 3 may be calculated, in which a digital brightness of the green light is 210 and a digital brightness of the blue light is 255. However, the disclosure is not limited thereto, and the distribution curve may also be obtained according to other fitting models. For example, the analog-to-digital conversion energy velocity corresponding to the maximum brightness level of the energy velocity curve C1 of the green light in FIG. 2 is used to serve as the reference analog-to-digital conversion energy velocity. As the quantum efficiency of the green light is greater than other colored lights, the straight line formed by the reference analog-to-digital conversion energy velocity at the multiple different brightness levels only intersects with the energy velocity curve of the analog-to-digital conversion energy velocity with respect to in-between the brightness levels of the green light, then the controller 80 may enable the other colored lights to be outputted with a maximum light intensity. Therefore, the distribution curve D2 in FIG. 3 may be obtained, in which the digital brightness of the green light is 255, and the digital brightness of the blue light is 255. However, the disclosure is not limited thereto, and the fitting model may also be a specific proportional relationship between the red light, the green light and the blue light. For example, according to another fitting model, a distribution curve D3 in FIG. 3 may be calculated, in which the digital brightness of the green light is 255, and the digital brightness of the blue light is 0 (that is, the light emitting pixels do not output the blue light).

Based on the above, since the controller 80 may use the fitting model to calculate the multiple distribution curves of the light intensity with respect to the position of the different colored lights at a specific time, so as to control the light emission of each of the light emitting pixels of the display module 20, the electronic device 100 according to the embodiment of the disclosure may select a better curve among the multiple distribution curves to control the light emission of the display module 20. The electronic device 100 according to the embodiment of the disclosure can reduce the impact of the moiré effect, increase the exposure time of the fingerprint sensing, and has a good sensing function.

With reference to FIG. 3 again, in an embodiment, the controller 80 averages the multiple distribution curves of the light intensity with respect to the position of the different colored lights at a specific time, so as to obtain an average curve E of the light intensity with respect to the position of the multiple different colored lights at a specific time, and control the light emission of each of the light emitting pixels of the display module 20 according to the average curve E. The average curve E in FIG. 3 is, for example, an average of the distribution curve D1. Therefore, compared to the distribution curve D1, the distribution curve D2, or the distribution curve D3, the controller 80 uses the average curve E to control the light emission of each of the light emitting pixels of the display module 20, so as to reduce a non-uniformed brightness issue in the distribution curve D1, the distribution curve D2, or the distribution curve D3, thereby improving the user experience.

In addition to the above-mentioned impact of the moiré effect generated by the under-screen fingerprint sensing, an intensity of an optical signal sensed by the sensing module 60 at a corresponding position close to a periphery of the fingerprint sensing region 22 is often lower than an intensity of an optical signal sensed by the sensing module 60 at a corresponding position close to a center of the fingerprint sensing region 22, causing the intensity of the optical signals obtained by the sensing module 60 to be different, which affects accuracy of the fingerprint sensing. For example, the lens in the optical module 40 is a non-planar lens, so that the fingerprint sensing generates a relative illumination (RI) phenomenon. For example, the intensity of the optical signals obtained by the sensing module 60 at a corresponding first region 222 and a corresponding second region 224 of the fingerprint sensing region 22 in FIG. 4 are different.

FIG. 4 is a schematic top view of the fingerprint sensing region of the display module in FIG. 1. With reference to FIG. 4, the fingerprint sensing region 22 may be divided into at least the first region 222 and the second region 224 from its center to its periphery, and when the light emitting element 20 provides the irradiation beam to irradiate the finger 10, the controller 80 controls a light emission time of the light emitting pixels in the first region 222 to be shorter than a light emission time of the light emitting pixels in the second region 224. In this way, light energy sensed by a center of the sensing module 60 is close to light energy sensed by an edge of the sensing module 60 per unit time (such as time of a single-time fingerprint sensing), enabling the image sensed by the sensing module to have a relatively uniformed brightness, while preventing a situation in which the image sensed by the prior art has a bright middle but a dark edge. In an embodiment, when the light emitting element 20 provides the irradiation beam to irradiate the finger 10, the controller 80 controls the light emission time of the light emitting pixels in the fingerprint sensing region 22 from the center to the periphery to show an increasing trend, which may further enable the brightness of the image sensed by the sensing module 60 to be uniformed across the entire surface, so as to further improve quality of the fingerprint image, thereby effectively improving a success rate and accuracy of fingerprint recognition.

In the embodiment, the electronic device 100 may control the light emission of each of the light emitting pixels of the display module 20 according to the above-mentioned control of the light emission time of the light emitting pixels in different regions in conjunction with each of the above-mentioned distribution curves D1, D2, or D3, or the average curve E calculated by the controller 80, so as to further improve the quality of the fingerprint image and improving success rate of the fingerprint sensing.

Incidentally, each of the distribution curves D1, D2, or D3, or the average curve E calculated by the controller 80, as well as the above-mentioned control of the light emission time of the light emitting pixels in the different regions, may be stored in a memory of the controller 80 after inspection by the inspector. That is to say, the various distribution curves D1, D2, or D3, or the average curve E of the embodiment of the disclosure, as well as the control of the light emission time of the light emitting pixels in the different regions, may be stored in the electronic device 100 before leaving the factory. Therefore, the electronic device 100 according to the embodiment of the disclosure provides more convenience to the user.

In an embodiment, the controller 80 is, for example, a central processing unit (CPU), a microprocessor, a digital signal processor (DSP), a programmable controller, a programmable logic device (PLD), or other similar devices, or a combination of these devices, but the disclosure is not limited thereto. In addition, in an embodiment, functions of the controller 80 may be implemented as multiple program codes. The program codes are stored in a memory, and the program codes are executed by the controller 80. Alternatively, in an embodiment, the functions of the controller 80 may be implemented as one or more circuits. The disclosure does not limit usage of software or hardware to implement the functions of the controller 80.

In summary, in the electronic device according to the embodiment of the disclosure, since the controller may calculate the multiple distribution curves of the light intensity with respect to the position of the different colored lights at a specific time, so as to control the light emitting pixels of the display module, the electronic device according to the embodiment of the disclosure can select a better curve among the multiple distribution curves to control the light emission of the display module. The electronic device according to the embodiment of the disclosure can reduce the impact of the moiré effect, increase the exposure time of the fingerprint sensing, and has a good sensing function.

Finally, it should be noted that the above embodiments are only illustrations of the technical solutions of the disclosure, and are not meant to limit the disclosure. Although the disclosure has been described in detail with reference to the foregoing embodiments, those of ordinary skill in the art should understand that modifications may be made to the technical solutions described in the foregoing embodiments, or equivalent replacements of some or all of the technical features may be done, however, these modifications or replacements do not cause the essence of the corresponding technical solutions to deviate from the scope of the technical solutions according to the embodiments of the disclosure.

What is claimed is:

1. An electronic apparatus, configured to sense a fingerprint image of a finger, comprising:
a display module, comprising a plurality of light emitting pixels arranged in an array, wherein the display module has a fingerprint sensing region, and is configured to provide an irradiation beam to the finger
a sensing module, disposed below the fingerprint sensing region, and is configured to receive the irradiation beam that reaches the sensing module after being reflected by the finger, so as to generate the fingerprint image; and
a controller, electrically connected to the display module, so as to control light emission of the display module,
wherein the controller calculates a plurality of distribution curves of light intensity with respect to position of different colored lights at a specific time, so as to control light emission of each of the light emitting pixels of the display module.

2. The electronic device according to claim 1, wherein the controller averages the plurality of distribution curves to obtain an average curve, and controls the light emission of each of the light emitting pixels of the display module according to the average curve.

3. The electronic device according to claim 1, wherein the controller calculates an energy velocity curve of an analog-to-digital conversion energy velocity with respect to in-between brightness levels of a green light and a blue light emitted by each of the light emitting pixels of the display module, so as to calculate the plurality of distribution curves.

4. The electronic device according to claim 3, wherein the controller uses a fitting model to calculate the plurality of distribution curves, wherein the fitting model selects a reference analog-to-digital conversion energy velocity for the controller, and obtains an intersection point of a straight line formed by the reference analog-to-digital conversion energy velocity at a plurality of different brightness levels and the plurality of energy velocity curves of the analog-to-digital velocity with respect to the in-between the brightness levels of the green light and the blue light, and uses a brightness level corresponding to the interception point to respectively serve as a light intensity of the green light and the blue light of each of the light emitting pixels corresponding to the intersection point.

5. The electronic device according to claim 3, wherein the reference analog-to-digital conversion energy speed is an analog-to-digital conversion energy velocity corresponding to a maximum brightness level of an energy velocity curve of the analog-to-digital conversion energy velocity with respect to brightness levels of the blue light.

6. The electronic device according to claim 3, wherein the controller calculates a growth rate ratio of an accumulated total energy per unit time with respect to moiré response of a red light, the green light and the blue light, so as to calculate an energy velocity curve of the analog-to-digital conversion energy velocity with respect to the in-between the brightness levels of the red light, the green light, and the blue light emitted by each of the light emitting pixels.

7. The electronic device according to claim 6, wherein the controller calculates a moiré response of the green light at the fingerprint sensing region, and correspondingly calculates the accumulated total energy of the red light and the blue light at the fingerprint sensing region at a specific time according to the moiré response of the green light, so as to calculate the growth rate ratio of the accumulated total energy per unit time with respect to the moiré response of the red light, the green light and the blue light.

8. The electronic device according to claim 7, wherein the controller calculates the moiré response of the green light at the fingerprint sensing region according to the accumulated total energy of the green light at the fingerprint sensing region within the specific time obtained by the sensing module.

9. The electronic device according to claim 1, wherein the display module is a transparent display panel.

10. The electronic device according to claim 9, wherein the transparent display panel is an organic light emitting diode display panel.

11. The electronic device according to claim 1, wherein the sensing module comprises an image sensor.

12. The electronic device according to claim 1, wherein the fingerprint sensing region is divided into at least a first region and a second region from a center to a periphery of the fingerprint sensing region, and an intensity of an optical signal emitted by the light emitting pixel located in the first region is lower than an intensity of an optical signal emitted by the light emitting pixel located in the second region.
